(19) United States
(12) Patent Application Publication
(10) Pub. No.: US 2006/0254117 A1
(43) Pub. Date: Nov. 16, 2006

(54) Dip bait tool

(76) Inventor: Leslie H. Hobbs, Streetman, TX (US)

Correspondence Address: CARDINAL LAW GROUP, Suite 2000, 1603 Orrington Avenue, Evanston, IL, 60201, US

(21) Appl. No.: 11/392,073

(22) Filed: Mar. 29, 2006

Related U.S. Application Data
(60) Provisional application No. 60/666,070, filed on Mar. 29, 2005.

(51) Int. Cl. A01K 83/06

(52) U.S. Cl. 43/4; 43/44.2

(57) ABSTRACT

A dip bait device includes an elongated body portion including a hook catch end portion. The hook catch end portion includes a notch to engage with a hook and allow placement of the hook into a dip bait container.

### RELATED APPLICATIONS

This application claims priority to U.S. Provisional Patent Application 60/666,070 filed Mar. 29, 2005. The entirety of that application is incorporated by reference.

### FIELD OF THE INVENTION

The invention relates to tools for fishing using dipworms.

### BACKGROUND OF THE INVENTION

Many people fish using dipworms coated in dip bait and treble hooks. Such bait includes a hook, often with 3 prongs, surrounded by a “worm” made of sponge or rubber material. The worm, and treble hook/s, are dipped, or punched, into a volume of dip bait to absorb or soak up the dip bait. Upon casting the baited dip worm, the bait elutes from the worm, releasing a scent and/or flavor particles that are intended to be pleasing to fish. However, the scents that are pleasing to fish, are often unpleasant to humans and it is undesirable to get the bait on the user's skin or clothing. This invention advances the art.

### SUMMARY OF THE INVENTION

One embodiment of the invention provides a dip bait device including an elongated body portion including a hook catch end portion. The hook catch end portion includes a notch to engage with a hook and allow placement of the hook into a dip bait container.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

The present invention is illustrated by way of example and not limitation in the accompanying figures, in which like references indicate similar elements, and in which:

FIG. 1A illustrates a front view of a dip bait device in accordance with one embodiment of the invention;

FIG. 1B illustrates a side view of a dip bait device in accordance with one embodiment of the invention;

FIG. 1C illustrates a cross sectional view along line C-C of a dip bait device shown in FIG. 1A, in accordance with one embodiment of the invention;

FIG. 1D illustrates a cross sectional view taken along line C-C of a dip bait device shown in FIG. 1A, in accordance with one embodiment of the invention;

FIG. 2A illustrates a front view of a dip bait device in accordance with another embodiment of the invention;

FIG. 2B illustrates a side view of a dip bait device in accordance with the other embodiment of the invention;

FIG. 2C illustrates a cross sectional view taken along line E-E of a dip bait device shown in FIG. 2A in accordance with one embodiment of the invention; and

FIG. 3 illustrates one embodiment of another dip bait device in accordance with the invention.

### DETAILED DESCRIPTION OF THE PREFERRED EMBODIMENTS

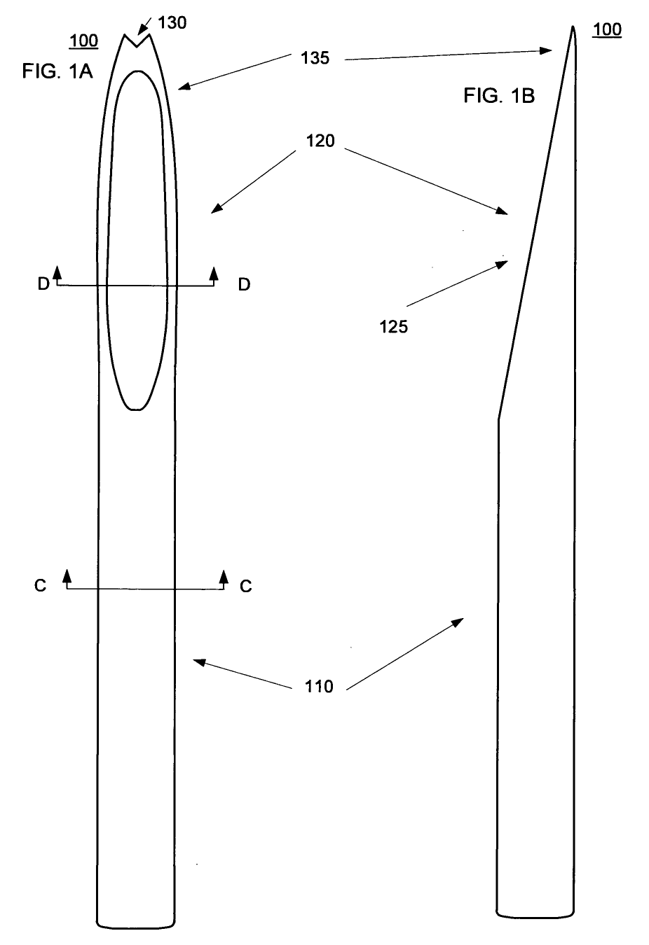

FIGS. 1A and 1B illustrate a front view and side view respectively of one embodiment of a dip bait device 100 in accordance with one aspect of the invention. Dip bait device 100 includes an elongated body portion 110 and a hook catch end portion 120. Hook catch end portion 120 includes a notch 130 (not visible in FIG. 1B) to engage with a hook and allow placement of the hook into a dip bait container.

In one embodiment, the elongated body portion includes a cylindrical portion. Such an embodiment is illustrated in FIGS. 1A, 1B, 1C and 1D. FIG. 1C is a cross sectional view of the elongated body portion taken along line C-C illustrated in FIG. 1A. As seen in FIG. 1C, the cross section is a cylindrical cross section along C-C. However, a cross sectional view taken along line D-D, as shown in FIG. 1D shows a more crescent shaped as the cylinder has a nonparallel and non-perpendicular slice to taper (125 in FIG. 1B) the cross section to a point at the notch 130. In such an embodiment, the hook catch end portion tapers from the cylindrical portion to a flat tip region 135, the notch 130 formed in the flat tip region 135.

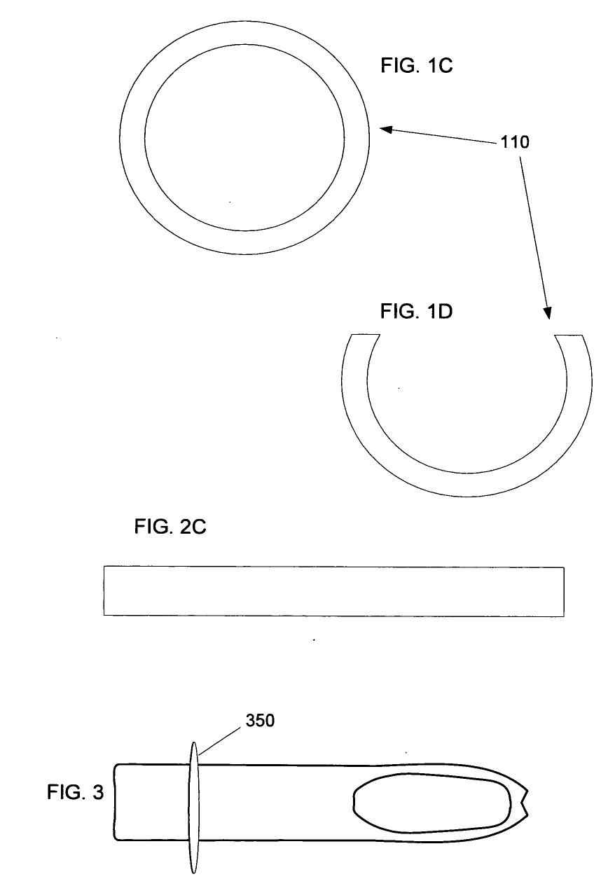

In another embodiment, the device comprises a planar member as illustrated in FIGS. 2A, 2B, and 2C. FIG. 2A illustrates a front view, FIG. 2B illustrates a side view, and FIG. 2C illustrates a cross sectional view of the device as a planar member at line E-E.

In one embodiment, the device comprises PVC tubing. In another embodiment, the device comprises stainless steel, aluminum, or other material configured to have sufficient strength as to resist bending when the device engages with a hook and is placed into a dip bait container.

In embodiments employing a cylindrical body portion, the outer diameter of the body portion should be sized to comfortably fit within a human hand. In embodiments employing a planar body portion, the thickness of the body portion should be sized to comfortably fit within a human hand. The length of the device should be sized so that the device is configured to be held in a human hand so that the hook catch end portion is not held by the hand, and so that the hook catch end portion is long enough to enter a dip bait bucket so that the elongated body portion does not enter the dip bait bucket. In one embodiment, the body portion is approximately ¾ inch and the entire device is approximately one foot long.

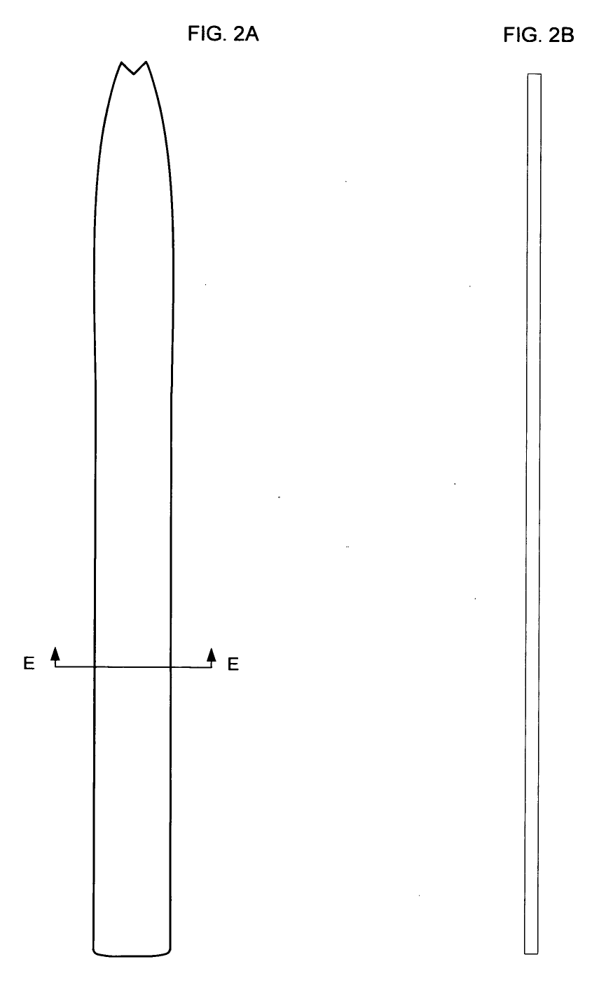

FIG. 3 illustrates an embodiment of the device featuring a guard 350 surrounding the elongated body portion. The guard 350 should be sized such that the inner diameter of the guard 350 tightly grips the outer diameter of the body portion. The outer diameter of the guard 350 can extend any appropriate distance. In one embodiment, the guard 350 is sized to prevent dripping of the dip bait onto the body portion, and onto the hand holding the body portion. In another embodiment, the guard 350 is sized to prevent the body portion from entering the dip bait bucket. In one embodiment, the guard 350 comprises an o-ring. In one embodiment, the guard 350 is removable. In one embodiment, guard 350 includes a clip configured to removably attach to a bait bucket.

It should be noted that the device could also be used as a hook or bait remover.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A dip bait device, comprising:
an elongated body portion and a hook catch end portion, the hook catch end portion including a notch to engage with a hook and allow placement of the hook into a dip bait container.

2. The device of claim 1 wherein the elongated body portion includes a cylindrical portion.

3. The device of claim 2 wherein the end portion tapers from the cylindrical portion to a flat tip region, the notch formed in the flat tip region.

4. The device of claim 1 wherein the device comprises PVC tubing.

5. The device of claim 1 wherein the device is a planar member

6. The device of claim 1 wherein the elongated body portion is sized to fit within a human hand.

7. The device of claim 1 wherein the device is configured to be held in a human hand and sized so that the hook catch end portion is long enough to enter a dip bait bucket and long enough so that the elongated body portion does not enter a dip bait bucket.

8. A dip bait device comprising:
an elongated body portion, and
means for engaging a hook for placement in a dip bait container.
